(19) United States
(12) Patent Application Publication
(10) Pub. No.: US 2020/0410794 A1
(43) Pub. Date: Dec. 31, 2020

(54) CONFIGURABLE ACCESS CONTROLLER, AND RELATED SYSTEMS, METHODS, AND DEVICES

(71) Applicant: Microchip Technology Incorporated, Chandler, AZ (US)

(72) Inventor: Stefan Dziaba, JR., Colorado Springs, CO (US)

(21) Appl. No.: 16/654,807

(22) Filed: Oct. 16, 2019

Related U.S. Application Data
(60) Provisional application No. 62/866,542, filed on Jun. 25, 2019.

(51) Int. Cl. G07C 9/00; B60R 25/24; E05B 81/78; B60R 25/23; G08C 19/28

(52) U.S. Cl. CPC G07C 9/00309; B60R 25/24; E05B 81/78; G07C 9/00182; G08C 2201/21; G08C 19/28; G07C 2009/00793; G07C 2209/63; B60R 25/23

(57) ABSTRACT

Access control devices are described, and systems including the same. An access control device may be configurable/reconfigurable such that it may communicate with a variety of keyless entry systems. Such keyless entry systems may control access to vehicles, buildings, facilities, containers, or other target resources, where access is controlled by way of devices for securing, for example, doors, windows, gates, and lids, without limitation.

### CROSS-REFERENCE TO RELATED APPLICATION

This application claims the benefit of the priority date of U.S. Provisional Patent Application No. 62/866,542, filed Jun. 25, 2019, and titled “Configurable Access Controller, and Related Systems, Methods and Devices,” the contents and disclosure of which is incorporated herein in its entirety by this reference.

### TECHNICAL FIELD

Disclosed embodiments herein relate, generally, to access control systems, and more specifically, some embodiments relate to a configurable/re-configurable access controller that may be used with a variety of different access controls systems.

### BACKGROUND

A keyless entry system is an access control system that uses an electronic key instead of a traditional mechanical key. In a typical arrangement, while an electronic key associated with a system is within a pre-determined distance of the access control system, a user may push a button or manipulate the electronic key in some other pre-defined manner associated with locking or unlocking. This causes the electronic key to wirelessly send an encoded message that includes a unique identifier associated with the electronic key. If the access control system recognizes the encoded message, then it controls an electronic lock to lock or unlock as the case may be.

An electronic key is typically a self-contained device (e.g., processor, battery, transceivers, without limitation, contained in a housing that may or may not have buttons) and ambulatory, meaning it may be carried, for example, in a pocket or purse far away from an access control system. Additionally, or alternatively, to pushing a button on an electronic key, a user may push a button connected to an access control system (e.g., on a door handle, without limitation). In a contemplated use case, upon a user pushing a button connected to an access control system of an automobile, the access control system sends an interrogating signal that energizes the electronic key and causes the electronic key to send an encoded message. Keyless entry systems are used, as non-limiting examples, to lock/unlock doors and/or trunk of a vehicle; and to lock/unlock doors, windows, and/or elevators of buildings (residential and commercial).

### BRIEF DESCRIPTION OF THE DRAWINGS

To easily identify the discussion of any particular element or act, the most significant digit or digits in a reference number refer to the figure number in which that element is first introduced.

FIG. 1 shows a block diagram of a system for configuring/re-configuring an access controller to operate with a keyless entry system, in accordance with one or more embodiments.

FIG. 2 shows a flowchart of a process for configuring/re-configuring a configurable access controller, in accordance with one or more embodiments.

FIG. 3 shows a block diagram of a system that includes a configurable access controller that has been configured to communicate with a keyless entry system, in accordance with one or more embodiments.

FIG. 4 shows an embodiment of a process for using a configurable access controller to control a keyless entry system, in accordance with one or more embodiments.

FIG. 5 shows a block diagram of a system for unlocking a trunk of a vehicle that is access-controlled by a keyless entry system using a configurable access controller installed at the vehicle, in accordance with one or more embodiments.

FIG. 6 shows a diagram of a configuration file, in accordance with one or more embodiments of the disclosure.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, “configurable” means configurable and re-configurable.

Keyless entry systems (KES) are typically configured for a specific communication protocol, and tuned to specific radio frequency (RF) characteristics. So, an electronic key sends messages to a KES according to the communication protocol of the KES, and the electronic key wirelessly transmit the messages on a carrier exhibiting the RF characteristics of the KES. A KES that uses a specific communication protocol and that is tuned to specific RF characteristics of carrier signals should not respond to messages from an electronic key that sends messages using a different communication protocol or different RF characteristics. So, unless an electronic key sends messages to a KES using a communication protocol and RF characteristics of the KES, the KES will not learn an identifier of the electronic key (in the case of initial setup of an electronic key to work with the KES), nor will the KES respond to control messages (e.g., lock, unlock, open door, without limitation) sent by a known electronic key.

In order to implement a robust electronic key that can operate with KESs that implement a variety of communication protocols and are tuned to a variety of RF characteristics, one option is for an electronic key is to include a memory large enough to store configuration information for multiple KESs. However, even with a large memory, such an electronic key is still limited to operation with those KESs for which configuration information is stored. Some, or all, of the stored configuration information may eventually become obsolete for respective KESs. Moreover, a large memory may require physical space for the memory to reside and/or expensive high-density memory.

One or more embodiments relate, generally, to a configurable access controller that is configured to interface with a keyless entry system, and systems for configuring and/or operating the access controller such that, as a non-limiting example, an authorized party may access a vehicle, building, container, facility, room, or other access controlled resource (all referred to herein as a “target resource” for ease of description, but without limitation), where access to a target resource is controlled by the keyless entry system.

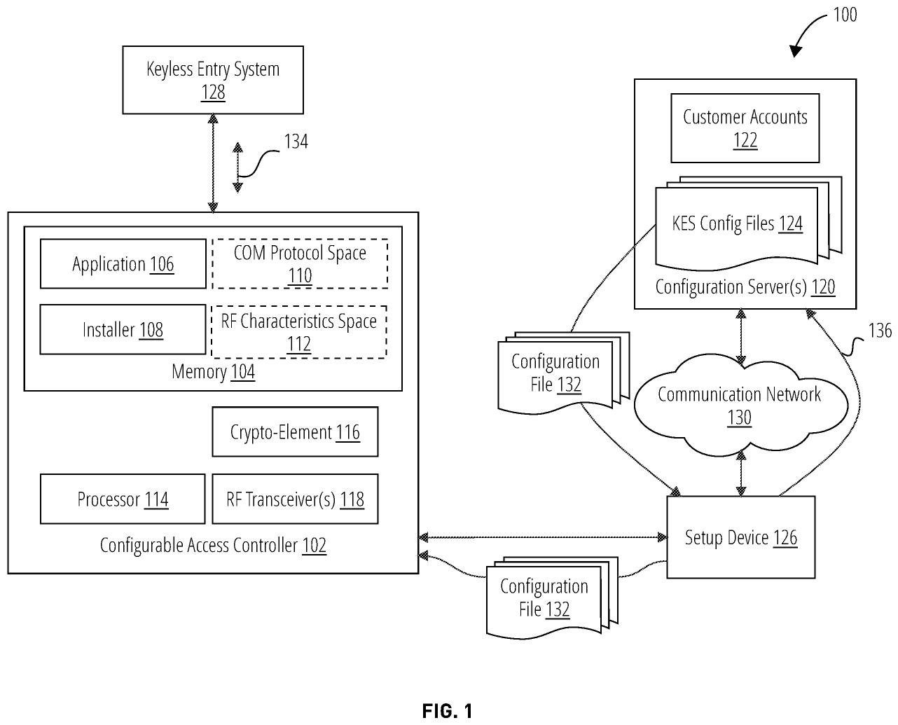

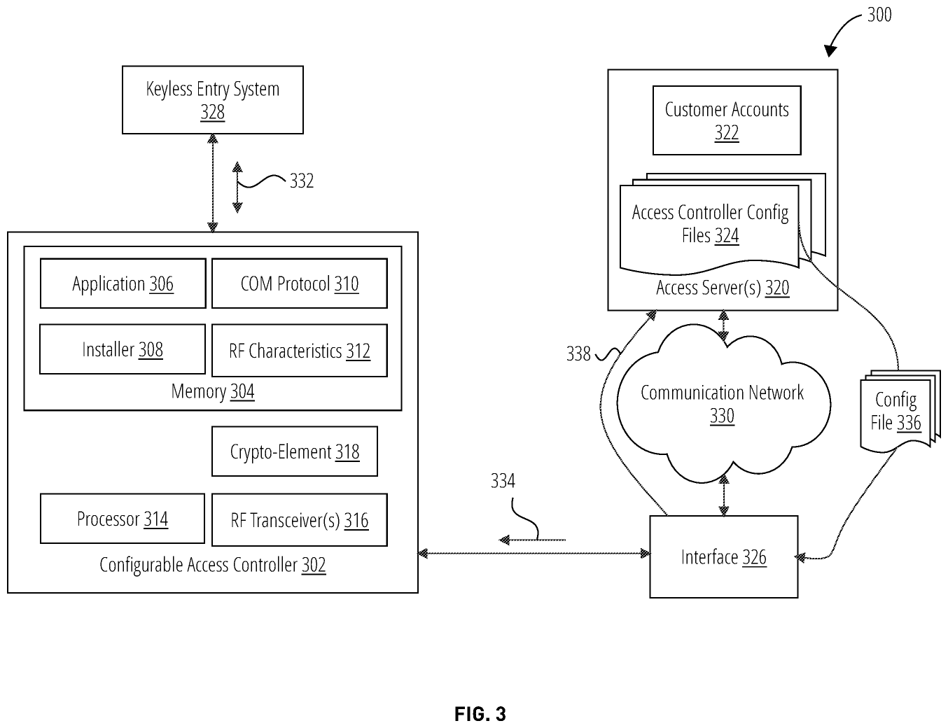

FIG. 1 and FIG. 3 show block diagrams of systems that include configurable access controllers, in accordance with one or more embodiments.

FIG. 1 shows a block diagram of an embodiment of a system 100 for configuring a configurable access controller (e.g., configurable access controller 102) to operate with a keyless entry system (e.g., keyless entry system 128), in accordance with one or more embodiments. In the scenario shown in FIG. 1, configurable access controller 102 has not yet been configured to communicate with keyless entry system 128, and keyless entry system 128 has not yet learned about configurable access controller 102.

FIG. 3 shows a block diagram of an embodiment of a system 300 that includes a configurable access controller (e.g., configurable access controller 302) that is already configured to communicate with a keyless entry system (e.g., keyless entry system 328), and more specifically, to send control messages (e.g., control message 332) to the keyless entry system (e.g., to keyless entry system 328), in accordance with one or more embodiments. In the scenario shown in FIG. 3, configurable access controller 302 has been configured to communicate with keyless entry system 328, and keyless entry system 328 has learned an identifier for configurable access controller 302.

The scenarios contemplated by FIG. 1 and FIG. 3 involve access to vehicles, but as discussed above, disclosed embodiments are not so limited and may be used for example, to access any target resource, such as a building, a container, and a fenced area, without limitation.

In the embodiment shown in FIG. 1, system 100 includes a configurable access controller 102, a keyless entry system 128, a setup device 126, and configuration server(s) 120.

Setup device 126 may be configured, generally, to enable a user to configure configurable access controller 102 such that configurable access controller 102 may communicate with keyless entry system 128. As non-limiting examples, a user may be a person, a controller, an automated software process, an artificial intelligence (AI) process, and combinations thereof. As a non-limiting example, setup device 126 may be a general purpose computing device configured to perform various functions of disclosed embodiments of setup device 126, such as a smartphone, tablet computer, laptop computer, desktop computer, or a wearable device, without limitation.

As shown in FIG. 1, setup device 126 and configuration server(s) 120 may be configured to communicate with each other via a communication link that includes communication network 130. Setup device 126 may also be configured to communicate with configurable access controller 102 via another communication link. Setup device 126 and configurable access controller 102 may be configured to communicate using any of a number of wireless communication protocols, including Bluetooth, Near Field Communication, cellular communication, and WiFi, and/or any one of a number of wired communication protocols such as one or more versions and form factors of Universal Serial Bus (USB), FireWire, optical data transfer, Ethernet, and High Definition Multimedia Interface, without limitation.

Setup device 126 may be configured to provide a prompt (e.g., a graphical user interface (GUI) provided at a display of setup device 126, the GUI including one or more GUI elements for providing instructions and for entering information (e.g., fields, menus, without limitation)) to a user to enter information that may be used to identify a target resource (e.g., target identification information) and/or a keyless entry system 128. Setup device 126 may be configured to generate and send requests that include target identification information entered at setup device 126 to configuration server(s) 120. The requests may be requests for configuration files that define rules for communicating with keyless-entry systems.

In FIG. 1, setup device 126 sends request 136 for configuration file 132 to configuration server(s) 120 through communication network 130. Request 136 may include any information suitable for identifying keyless entry system 128 such that configuration server 120 may search for and retrieve configuration files associates with keyless entry system 128 (here, configuration file 132). Setup device 126 is further configured to forward the received configuration file 132 to configurable access controller 102.

In a vehicle access scenario, the information for identifying keyless entry system 128 may include a vehicle make and/or a vehicle model. In another embodiment, the information for identifying keyless entry system 128 may include a specific identifier identifying a make or a model of keyless entry system 128.

Configuration server(s) 120 may be configured, generally, to store keyless entry system configuration files 124 and to associate keyless entry system configuration files 124 with customer accounts 122. As a non-limiting example, upon receiving a request for a configuration file 132 (in theory, one of the configuration files of keyless entry system configuration files 124) together with target identifying information, configuration server 120 may be configured to search for and retrieve a specific keyless entry system configuration file 132 that is associated with the target identifying information from stored keyless entry system configuration files 124. Configuration server 120 may be configured to send the retrieved keyless entry system configuration file 132 to setup device 126. In various embodiments, a user may also enter customer profile information at setup device 126, and send the customer profile information to configuration server(s) 120. Upon configuration server(s) 120 determining that no customer account exists in customer accounts 122 for the provided customer profile information, then configuration server(s) 120 may create a new customer account using the customer profile information and associated keyless entry configuration file 132 with the new customer account. Upon configuration server(s) 120 determining that a customer account exists in customer accounts 122 for the provided customer profile information, then configuration server(s) 120 may add associated keyless entry configuration file 132 from stored keyless entry system configuration files 124 with the existing customer account.

In one embodiment, respective keyless entry system configuration files 124 may include RF characteristics and communication (COM) protocols associated with keyless entry systems used with various makes, models, and years of vehicles, and customer accounts 122 may store the make, model and year of a vehicle associated with a specific customer account.

Configurable access controller 102 may include memory 104, processor 114, crypto-element 116, and RF transceiver(s) 118. Memory 104 may be configured to store various modules, including one or more of application 106, installer 108, as well as communication modules. Notably, in the scenario contemplated by FIG. 1, no communication module is installed at configurable access controller 102, but space in memory is reserved as COM protocol space 110. Space is also reserved to store RF characteristics, here, RF characteristics space 112. Two code spaces are shown in FIG. 1 merely to highlight functional independence, but notably, COM protocol space 110 and RF characteristics space 112 may be located on the same memory device at predetermined locations, located on different memory devices, or located on the same memory device on overlapping or interleaved locations, without limitation.

As non-limiting examples, memory 104 may be or include one or more of a Flash memory, electrically erasable programmable read-only memory electrically erasable programmable read-only memory (EEPROM), and read-only memory (ROM), random access memory (RAM), without limitation. In one embodiment, application 106 and COM protocol space 110 may be stored on a Flash memory or RAM, RF characteristics space 112 may be stored on an EEPROM, and installer 108 may be stored on a ROM.

As non-limiting examples, RF characteristics (such as RF characteristics stored at configuration server(s) 120 and RF characteristics 312 of FIG. 3, without limitation) storable at RF characteristics space 112 may include one or more of frequency, modulation type (e.g., amplitude-shift key modulation or frequency-shift keying modulation, without limitation), data rate, and output power. As non-limiting examples, communication protocol instructions (such as communication protocols stored at configuration servers 120 and COM protocol 310) storable at COM protocol space 110, may include rules for formatting messages sent to keyless entry system 128. Rules for formatting messages, as non-limiting examples, may include rules for contents of data packets that comprise a message. Contents may include identifiers, command codes such as command codes for lock, unlock, open, and error correction (e.g., checksum, cyclic redundancy check, without limitation).

In FIG. 1, COM protocol space 110 and RF characteristics space 112 are depicted having a border including a dashed line. In a contemplated scenario the dashed lines indicate that no instructions and/or parameters are presently stored. In another contemplated scenario, the dashed lines indicate that instructions and/or parameters stored at COM protocol space 110 and RF characteristics space 112 will be replaced.

Installer 108 may be configured, generally, to enable configurable access controller 102 (and processor 114 executing installer 108 more specifically) to receive configuration file 132 including COM protocols and RF characteristics, and to store such RF characteristics and COM protocols at COM protocol space 110 and RF characteristics space 112, respectively.

Application 106 may be configured, generally, to enable configurable access controller 102 (and processor 114 executing application 106 more specifically) to send messages to keyless entry system 128, such as control message 134 (e.g., unlock, lock, open door, or close door, without limitation) using COM protocols and RF characteristics (once installed) stored at memory 104. Configurable access controller 102 may be configured to access and use COM protocols and RF characteristics stored at COM protocol space 110 and RF characteristics space 112, respectively, to format messages and configure RF signals that carrying the messages.

Crypto-element 116 may be configured, generally, to perform an authentication process with setup device 126, as a non-limiting example, a challenge-response process that uses public and/or private keys. Crypto-element 116 may comprise one or more memories for storing a unique identifier associated with configurable access controller 102, and crypto-element 116 may be configured to provide such an identifier to processes at configurable access controller 102 such as processes for pairing configurable access controller 102 with keyless entry system 128, or sending instructions to keyless entry system 128 to unlock or lock.

RF transceiver(s) 118 may be configured, generally, to send RF signals that exhibit the RF characteristics stored at RF characteristics space 112 and that carry messages sent using COM protocols stored at COM protocol space 110.

Keyless entry system 128 may be configured to use a specific COM protocol and be tuned to specific RF characteristics of carrier signals, and will not respond to messages that do not comply with the COM protocol or RF characteristics.

Configurable access controller 102 may be configured to send control message 134 to keyless entry system 128, including while keyless entry system 128 is in a learn mode of operation (i.e., an operational mode during which keyless entry system 128 may add devices to its list of authorized devices). In one embodiment, control message 134 may include a coded message that includes an identifier associated with (i.e., uniquely identifying) configurable access controller 102 and/or commands (e.g., open, close, lock, unlock, without limitation).

In one or more embodiments, keyless entry system 128 may be placed in a learning mode of operation by a user, as a non-limiting example, by activating a button or switch. While in a learning mode of operation, keyless entry system 128 may be configured to store an identifier sent in a control message (e.g., control message 134) that is a properly formatted and/or encoded message (i.e., using COM protocols stored at COM protocol 310) at a list of approved identifiers.

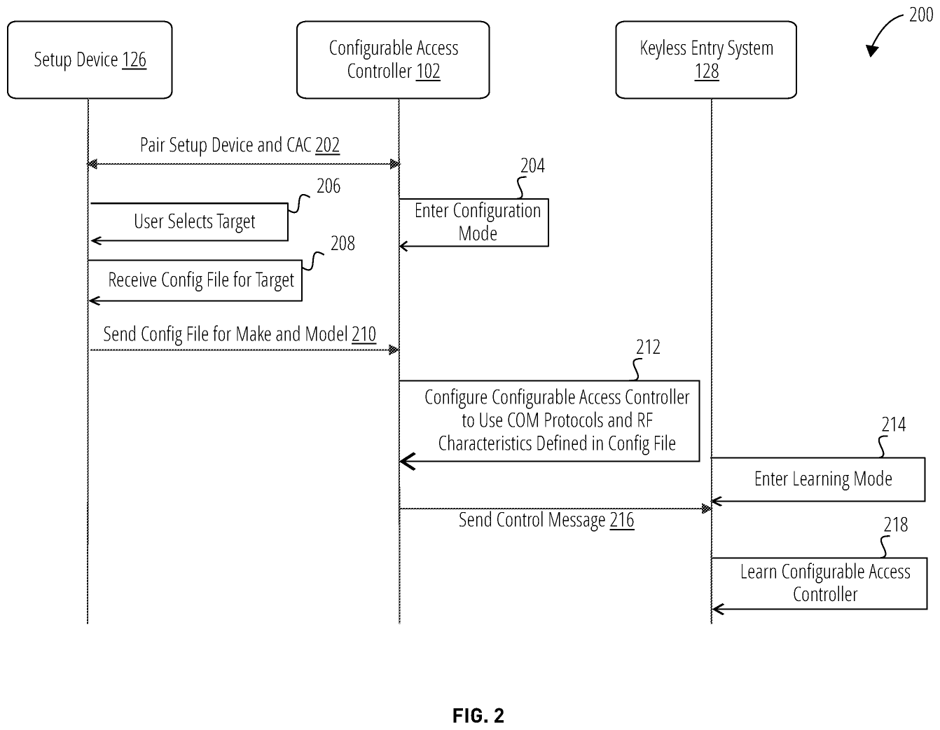

FIG. 2 shows an embodiment of a configuration/re-configuration process 200 performed by setup device 126, configurable access controller 102, and keyless entry system 128 of system 100.

In operation 202, setup device 126 and configurable access controller 102 are paired, for example, by way of an authentication process that involves using public/private keys.

In operation 204, configurable access controller 102 enters a configuration mode of operation in response to pairing with setup device 126 in operation 202.

In operation 206, a user selects an identifier of the target keyless entry system 128, as a non-limiting example, by providing a vehicle make and a vehicle model at setup device 126. In one embodiment, setup device 126 may provide a prompt at a display thereof, the prompt including fields for entering text for vehicle make or vehicle model.

In operation 208, setup device 126 receives a configuration file (e.g., configuration file 132 of FIG. 1) for the vehicle make and vehicle model selected in operation 206. The configuration file may include instructions for a COM protocol and information about RF characteristics. As indicated above in relation to FIG. 1, in one embodiment, setup device 126 may retrieve configuration file 132 from configuration server 120.

In operation 210, setup device 126 sends the configuration file to configurable access controller 102 for installation.

In operation 212, configurable access controller 102 configures itself to use the COM protocol and RF characteristics in the configuration file received in operation 210.

In operation 214, keyless entry system 128 enters a learning mode of operation. In one embodiment, keyless entry system 128 may enter the learning mode of operation in response to performance of pre-specified interactions with keyless entry system 128, as a non-limiting example, pushing and holding a button connected to keyless entry system 128.

In operation 216, configurable access controller 102 sends a control message to keyless entry system 128 according to the COM protocol and RF characteristics stored at configurable access controller 102. The control message may include, as a non-limiting example, an identifier for configurable access controller 102.

In operation 218, keyless entry system 128 “learns” configurable access controller 102 such that keyless entry system 128 will respond to control messages including commands that are received from configurable access controller 102. Learning configurable access controller 102 may include setting/configuring keyless entry system 128 to respond to control messages from configurable access controller 102. As a non-limiting example, keyless entry system 128 may update an internal list of learned access controllers to include an identifier for configurable access controller 102.

In the embodiment shown in FIG. 3, system 300 may include configurable access controller 302, keyless entry system 328, access server(s) 320 and interface 326. As mentioned above, in the scenario contemplated by FIG. 3, configurable access controller 302 has been configured to communicate with keyless entry system 328. More specifically, COM protocol 310 and RF characteristics 312 are installed at memory 304, and configurable access controller 302 may send and/or receive control messages to and/or from keyless entry system 328 using COM protocol 310 and RF characteristics 312.

For example, during a contemplated communication from configurable access controller 302 to keyless entry system 328, configurable access controller 302 may format control message 332 according to COM protocol 310 and to control RF transceiver(s) 316 such that carrier signals emitted from RF transceiver(s) 316 that carry control message 332 exhibit one or more of the RF characteristics 312.

Configurable access controller 302, and more specifically, processor 314 executing application 306, may be configured to send control messages in response to a request received from interface 326. As non-limiting examples, interface 326 may be a general purpose computing device programmed to perform various functions of embodiments of interface 326 described herein. In the example of FIG. 3, configurable access controller 302 is configured with COM protocol 310 and RF characteristics 312, which enable it to communicate with keyless entry system 328. In one embodiment, configurable access controller 302 is configured to send control message 332 to keyless entry system 328 in response to receiving an access request 334 from interface 326. In one embodiment, configurable access controller 302, and more specifically, crypto-element 318, is configured to authenticate interface 326 and send control message 332 in response to access request 334 if the authentication is successful. In one embodiment, crypto-element 318 is configured to authenticate interface 326, for example, using a challenge response sequence involving public and/or private keys.

Notably, installer 308 is stored at memory 304. So, configurable access controller 302 may be reconfigured via installer 308, as non-limiting examples, to communicate with a keyless entry system that uses different COM protocols or is tuned to different RF characteristics than keyless entry system 328 or if the COM protocols and/or tuned RF characteristics of keyless entry system 328 change.

Interface 326 may be configurable to communicate with configurable access controller 302, e.g., over one or more communication links between configurable access controller 302 and interface 326. To communicate with configurable access controller 302, in some embodiments, interface 326 is configured for communication using configuration file 336. In FIG. 3, interface 326 sends request 338 for access configuration information to access server(s) 320 via a communication link that includes communication network 330. In response to request 338, access server(s) 320 sends configuration file 336 to interface 326, which configuration file 336 includes instructions to enable interface 326 to establish a communication link and communicate with configurable access controller 302.

In a vehicle access scenario, request 338 may include identifiers for a customer or a vehicle (e.g., a name, an address, an account number, a license plate number, without limitation). In one embodiment, identifiers for a customer or a vehicle may be provided to interface 326 by a user interface included at interface 326 (not shown), such as a touch screen, keyboard, pointer device, or natural language processor, without limitation.

Access server(s) 320 may be configured to retrieve requested configuration information included in access controller configuration files 324 associated with specific customers of customer accounts 322 based, at least in part, on identifiers in request 338 received from interface 326. Access server(s) 320 may be further configured to send configuration file 336 including such configuration information to interface 326. The configuration information in configuration file 336 may include access configuration information, that is, information to enable interface 326 to communicate with configurable access controller 302. Information to enable interface 326 to communicate with configurable access controller 302 may include, for example, credentials to authenticate interface 326 to configurable access controller 302.

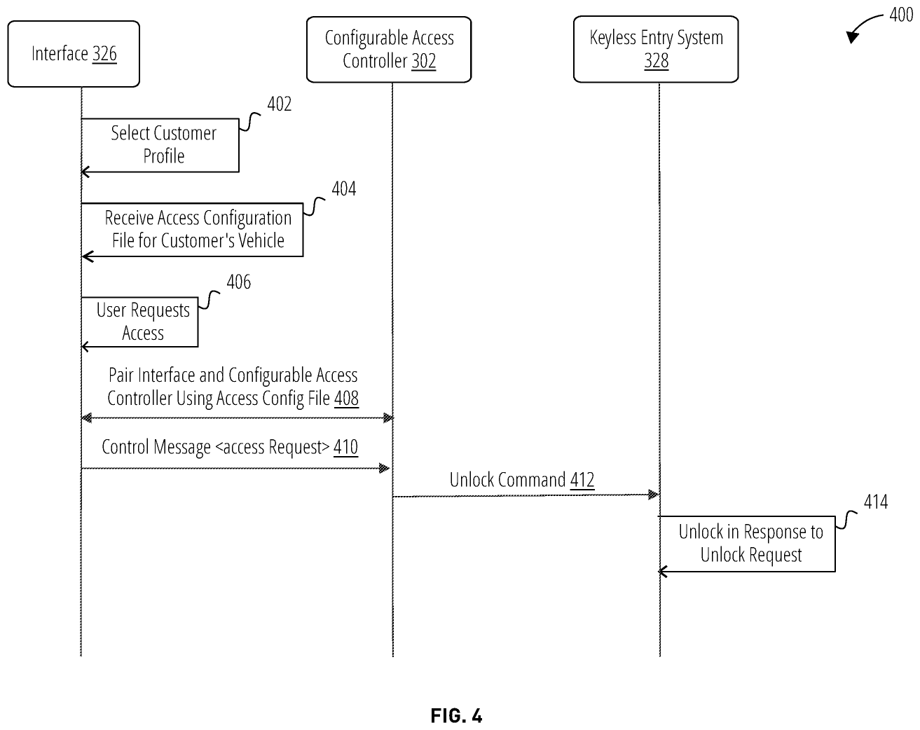

FIG. 4 shows an embodiment of a process 400 performed by interface 326, configurable access controller 302, and keyless entry system 328.

In operation 402, a customer profile is selected at interface 326. As a non-limiting example, the customer profile may be associated with a vehicle or other restricted resource for which access is controlled by keyless entry system 328. In a use case contemplated herein, selecting a customer profile may involve user selection of a customer profile at interface 326. In another use case contemplated herein, interface 326 may autonomously send location information to access server 320, access server 320 may match the location information to an address and match the address to a customer profile. Non-limiting examples of location information include an address, a global satellite navigation system coordinates, longitude and latitude, and media access control data (e.g., a MAC ID or MAC address, without limitation).

In operation 404, an access configuration file is received at interface 326 (e.g., downloaded from access server 320), the access configuration file (e.g., configuration file 336 of FIG. 3, without limitation) associated with the customer profile selected in operation 402. As non-limiting examples, the access configuration file may include one or more of instructions for communication protocols, RF characteristics, and authentication.

In operation 406, a request to access a vehicle controlled by keyless entry system 328 is received at interface 326. In one embodiment, the request for access may be initiated from within a customer profile selected in operation 402 upon successfully receiving the access configuration file in operation 404.

In operation 408, interface 326 pairs with configurable access controller 302 using instructions in the access configuration file 336 received in operation 404, thus establishing a communication link between interface 326 and configurable access controller 302, and interface 326 and configurable access controller 302 may communicate over such established communication link. In one embodiment, paring in operation 408 may be performed by using challenge/response pairs that involve public and/or private keys. Instructions in the access configuration file received in operation 404 may include credentials for performing such authentication.

In operation 410, interface 326 sends a request to access the vehicle controlled by keyless entry system 328 (e.g., access request 334, without limitation) to configurable access controller 302. The request is sent via the communication link established in operation 408.

In operation 412, configurable access controller 302 sends an unlock request to keyless entry system 328 in response to the request sent in operation 410. The unlock request is a control message (e.g., a control message 332 of FIG. 3), that is sent using COM protocols and RF characteristics installed at configurable access controller 302.

In operation 414, keyless entry system 328 unlocks the doors and/or trunk of the vehicle in response to the unlock request sent in operation 412. In this scenario, the COM protocols and RF characteristics used to send the unlock request in operation 412 matched the COM protocols and RF characteristics expected by keyless entry system 328, and the identifying information included in the request match identifying information for learned devices stored at keyless entry system 328. In another scenario, keyless entry system 328 may not respond to the request sent in operation 412 if the COM protocols and/or RF characteristics used to send the request (notably, if the received message does not comply with the COM protocols and exhibit the RF characteristics expected by keyless entry system 328, and the identifying information included in the request match identifying information for learned devices stored at keyless entry system 328) were not those expected by keyless entry system 328, and/or if the identifying information did not match identifying information for learned devices stored at keyless entry system 328.

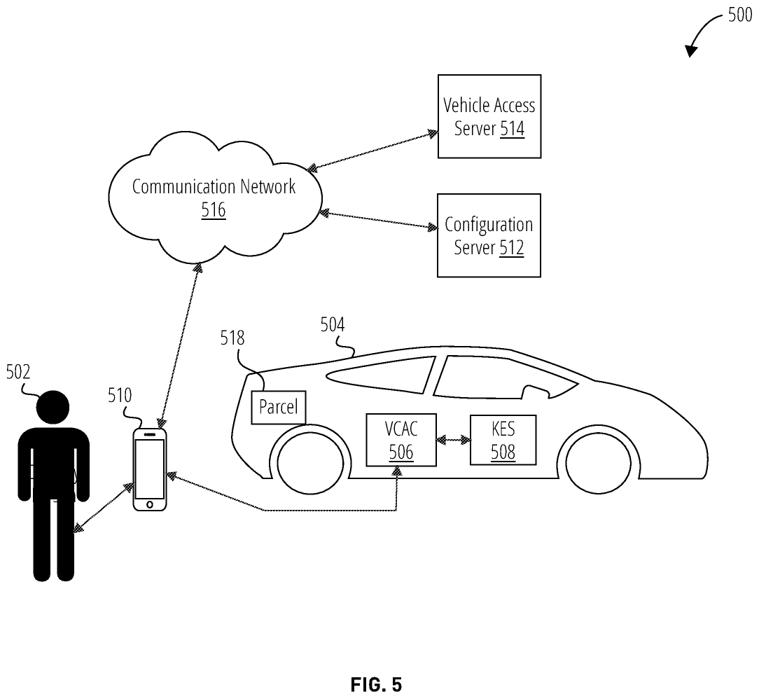

FIG. 5 shows a block diagram of a system 500 for unlocking a trunk of a vehicle 504 that is access-controlled by keyless entry system 508 using a vehicle configurable access controller 506.

In the scenario contemplated by FIG. 5, delivery person 502 intends to deposit parcel 518 in vehicle 504, and more specifically, in the trunk of vehicle 504. However, the means of access to vehicle 504 (i.e., windows, doors, and trunk) are locked, and under the control of keyless entry system 508.

In the scenario contemplated by FIG. 5, a delivery person 502 uses a mobile device 510 (e.g., a smartphone or custom device, without limitation) as an interface (e.g., interface 326 of FIG. 3, without limitation) to communicate with vehicle configurable access controller 506. A first communication link (here, a wireless communication link) has been established (as discussed herein) between mobile device 510 and vehicle configurable access controller 506, and mobile device 510 may send messages (e.g., requests to unlock, lock, and open, without limitation) to vehicle configurable access controller 506 via the first communication link. To unlock a trunk of vehicle 504, delivery person 502 may use mobile device 510 to send a message including an access request to vehicle configurable access controller 506 via the first communication link.

Notably, vehicle configurable access controller 506 may be physically located anywhere at vehicle 504 as long as it is able to form a communication link with mobile device 510 and a communication link with keyless entry system 508.

A second communication link (here, wired or wireless) is established between vehicle configurable access controller 506 and keyless entry system 508. The second communication link may be hard-wired, so as to be always available, or established in response to establishment of the first communication link. Vehicle configurable access controller 506 may send, in response to the access request from mobile device 510 sent on the first communication link, a control message to keyless entry system 508 via the second communication link. In this scenario, the control message may include a trunk unlock/open command, in response to which keyless entry system 508 unlocks and/or opens the trunk of vehicle 504 (opening of the trunk is not shown in FIG. 5).

Upon depositing parcel 518 in the trunk of vehicle 504, delivery person 502 may use mobile device 510 to send a message including a close and/or lock request to vehicle configurable access controller 506 via the first communication link. In response to the lock request, vehicle configurable access controller 506 may send a control message including a close and/or lock command to keyless entry system 508 via the second communication link. In response to the lock command, keyless entry system 508 closes and/or locks the trunk of vehicle 504.

Mobile device 510 is also in communication with vehicle access server 514, which includes an access server (e.g., access server(s) 320, without limitation), via a third communication link that includes communication network 516. In the scenario contemplated by FIG. 5, delivery person 502 may use mobile device 510 to select a customer profile associated with parcel 518 (e.g., a delivery address or recipient for parcel 518). Mobile device 510 may send vehicle access server 514 a request for authentication information needed to communicate with vehicle configurable access controller 506 via the third communication link. Vehicle access server 514, may confirm authorization of delivery person 502 or mobile device 510, and download to mobile device 510 an access code. Mobile device 510 may transmit this access code over the first communication link to vehicle configurable access controller 506. Vehicle configurable access controller 506 may verify the authenticity of the received access code, for example by public/private keys, and upon confirmation of authenticity, may command keyless entry system 508 to provide access to the trunk of vehicle 504.

Also shown in FIG. 5 is configuration server 512, although not used in the scenario discussed above, during set up of vehicle configurable access controller 506 to work with keyless entry system 508, configuration files with instructions for COM protocols and information about RF characteristics may be downloaded from configuration server 512 and stored at vehicle configurable access controller 506 so that vehicle configurable access controller 506 may setup a communication link with keyless entry system 508.

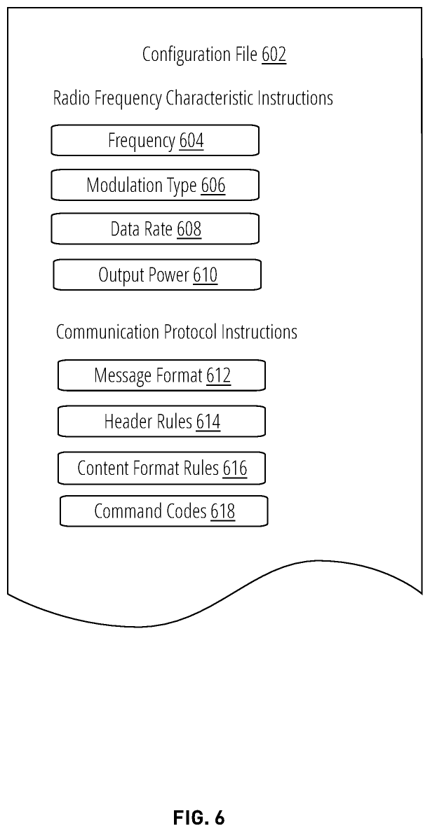

FIG. 6 shows a diagram of an embodiment of a configuration file 602 (i.e., an electronic file readable by a computer) usable to configure a configurable access controller, such as the configuration file 132 used to configure configurable access controller 102 of FIG. 1 to create configurable access controller 302 of FIG. 3, without limitation.

In the embodiment shown in FIG. 6, configuration file 602 includes fields for instructions for radio frequency characteristics and instructions for communication protocols. Fields for radio frequency characteristics include a field for frequency 604, a field for modulation type 606, a field for data rate 608, and a field for output power 610. Modulation types may be one or more of: amplitude-shift key modulation or frequency-shift keying modulation, without limitation. Fields for communication protocol instructions include a field for message format 612 (e.g., description of fields that should be included in a message, without limitation), a field for header rules 614 (e.g., rules for information for formatting information in a header, such as an identifier, without limitation), a field for content format rules 616 (e.g., rules for formatting content of various fields in a message defined in message format 612, such as command codes 618, without limitation, and/or rules for contents of data packets that comprise a message), and a field for command codes 618 (e.g., codes used to represent commands such as lock, unlock, open, close, without limitation). During a setup operation, an installer (e.g., installer 108, without limitation) may parse configuration file 602, read one or more contents of the fields, and store the contents at configurable access controller, (e.g., at COM protocol space 110 and/or RF characteristics space 112 of configurable access controller 102, without limitation).

Various networks may be implemented in accordance with embodiments of the disclosure, such as communication network 330 and communication network 130. Such networks may include wired paths, wireless paths, and a combination of wired and/or wireless paths. Such networks may include the Internet, an Extranet, an Intranet, an Ethernet, or any other system that enables communication.

One or more embodiments relate, generally, to an electronic key that includes a configurable access controller in accordance with one or more disclosed embodiments (e.g., configurable access controller 102, configurable access controller 302, and vehicle configurable access controller 506, without limitation).

One or more embodiments relate, generally, to a microcontroller type embedded system, the embedded system including one or more aspects of a configurable access controller in accordance with one or more disclosed embodiments (e.g., configurable access controller 102, configurable access controller 302, and vehicle configurable access controller 506, without limitation).

Notably, a transceiver may be a device configured as transmitter, receiver, or both. Moreover, a transceiver may be one device configured to receive and/or transmit RF signals, or it may be multiple devices, for example, one device configured to receive RF signals and another device configured to transmit RF signals.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting embodiments of the disclosure include:

Embodiment 1: a configurable access controller, comprising: a processor; a radio frequency (RF) transceiver; and one or more memories, the one or more memories having stored thereon: a first processor executable instructions, wherein the first processor executable instructions, when executed by the processor, enable the configurable access controller to store communication protocol instructions and radio-frequency (RF) characteristics at the one or more memories; and a second processor executable instructions, wherein the second processor executable instructions, when executed by the processor, enable the configurable access controller to send messages configured to identify the configurable access controller to a keyless entry system using a communication protocol associated with the communication protocol instructions and exhibiting at least one RF characteristic of the RF characteristics.

Embodiment 2: the configurable access controller according to Embodiment 1, wherein the messages comprise an identifier associated with the configurable access controller.

Embodiment 3: the configurable access controller according to any of Embodiments 1 and 2, further comprising: a crypto-element configured to authenticate a device attempting to establish a communication link with the configurable access controller.

Embodiment 4: the configurable access controller according to any of Embodiments 1 to 3, wherein the RF characteristics include one or more of: frequency, modulation type, data rate, and output power.

Embodiment 5: the configurable access controller according to any of Embodiments 1 to 4, wherein the modulation type is one or more of: amplitude-shift key modulation or frequency-shift keying modulation.

Embodiment 6: the configurable access controller according to any of Embodiments 1 to 5, wherein the first processor executable instructions are further configured to enable the configurable access controller to receive one or more configuration files that include instructions for a communication protocol and RF characteristics.

Embodiment 7: the configurable access controller according to any of Embodiments 1 to 6, wherein a control message of the messages includes a command for the keyless entry system.

Embodiment 8: the configurable access controller according to any of Embodiments 1 to 7, wherein the command is one of unlock, lock, open, and close.

Embodiment 9: the configurable access controller according to any of Embodiments 1 to 8, wherein the one or more memories include a first code space for storing communication protocol instructions.

Embodiment 10: the configurable access controller according to any of Embodiments 1 to 9, wherein the one or more memories include a second code space for storing the RF characteristics.

Embodiment 11: the configurable access controller according to any of Embodiments 1 to 10, wherein the communication protocol instructions include rules for formatting messages.

Embodiment 12: the configurable access controller according to any of Embodiments 1 to 11, wherein the rules for formatting messages include rules for contents of data packets that comprise a message.

Embodiment 13: a system, comprising: a configurable access controller; and an interface, wherein the interface is configured to: receive target identification information via a prompt; send a request for a configuration file, the request including the target identification information received via the prompt; receive a configuration file, the configuration file including instructions for communicating with a keyless entry system; and send the instructions to the configurable access controller.

Embodiment 14: the system according to Embodiment 13, further comprising: a configuration server, the configuration server configured to provide the requested configuration file.

Embodiment 15: the system according to any of Embodiments 13 and 14, wherein the instructions for communicating with the keyless entry system include one or more of radio-frequency (RF) characteristics and instructions for a communication protocol.

Embodiment 16: the system according to any of Embodiments 13 to 15, wherein the configurable access controller is configured to locally store the communication protocol and RF characteristics.

Embodiment 17: the system according to any of Embodiments 13 to 16, further comprising a keyless entry system, wherein the keyless entry system is configured to operate in a learning mode of operation, and to learn the configurable access controller that communicates with the keyless entry system while the keyless entry system operates in the learning mode of operation.

Embodiment 18: the system according to any of Embodiments 13 to 17, further comprising a keyless entry system, wherein the keyless entry system is configured to use a specific communication protocol and tuned to specific RF characteristics.

Embodiment 19: the system according to any of Embodiments 13 to 18, further comprising a keyless entry system, wherein the keyless entry system is configured to control access to a vehicle, a residential building, a commercial building, a facility, a fenced area, a container, or a room.

Embodiment 20: the system according to any of Embodiments 13 to 19, wherein the target identification information is one or more of a make and a model of a vehicle.

Embodiment 21: the system according to any of Embodiments 13 to 20, wherein the target identification information is chosen from a group including: a make of a vehicle, a model of a vehicle, an address, a global satellite navigation system coordinates, longitude and latitude, and media access control data.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A configurable access controller, comprising:
a processor;
a radio frequency (RF) transceiver; and
one or more memories, the one or more memories having stored thereon:
a first processor executable instructions, wherein the first processor executable instructions, when executed by the processor, enable the configurable access controller to store communication protocol instructions and radio-frequency (RF) characteristics at the one or more memories; and
a second processor executable instructions, wherein the second processor executable instructions, when executed by the processor, enable the configurable access controller to send messages configured to identify the configurable access controller to a keyless entry system using a communication protocol associated with the communication protocol instructions and exhibiting at least one RF characteristic of the RF characteristics.

2. The configurable access controller of claim 1, wherein the messages comprise an identifier associated with the configurable access controller.

3. The configurable access controller of claim 1, further comprising:
a crypto-element configured to authenticate a device attempting to establish a communication link with the configurable access controller.

4. The configurable access controller of claim 1, wherein the RF characteristics include one or more of: frequency, modulation type, data rate, and output power.

5. The configurable access controller of claim 4, wherein the modulation type is one or more of: amplitude-shift key modulation or frequency-shift keying modulation.

6. The configurable access controller of claim 1, wherein the first processor executable instructions are further configured to enable the configurable access controller to receive one or more configuration files that include instructions for a communication protocol and RF characteristics.

7. The configurable access controller of claim 1, wherein a control message of the messages includes a command for the keyless entry system.

8. The configurable access controller of claim 7, wherein the command is one of unlock, lock, open, and close.

9. The configurable access controller of claim 1, wherein the one or more memories include a first code space for storing communication protocol instructions.

10. The configurable access controller of claim 9, wherein the one or more memories include a second code space for storing the RF characteristics.

11. The configurable access controller of claim 1, wherein the communication protocol instructions include rules for formatting messages.

12. The configurable access controller of claim 11, wherein the rules for formatting messages include rules for contents of data packets that comprise a message.

13. A system, comprising:
a configurable access controller; and
an interface, wherein the interface is configured to:
receive target identification information via a prompt;
send a request for a configuration file, the request including the target identification information received via the prompt;
receive a configuration file, the configuration file including instructions for communicating with a keyless entry system; and
send the instructions to the configurable access controller.

14. The system of claim 13, further comprising:
a configuration server, the configuration server configured to provide the requested configuration file.

15. The system of claim 13, wherein the instructions for communicating with the keyless entry system include one or more of radio-frequency (RF) characteristics and instructions for a communication protocol.

16. The system of claim 15, wherein the configurable access controller is configured to locally store the communication protocol and RF characteristics.

17. The system of claim 13, further comprising a keyless entry system, wherein the keyless entry system is configured to operate in a learning mode of operation, and to learn the configurable access controller that communicates with the keyless entry system while the keyless entry system operates in the learning mode of operation.

18. The system of claim 13, further comprising a keyless entry system, wherein the keyless entry system is configured to use a specific communication protocol and tuned to specific RF characteristics.

19. The system of claim 13, further comprising a keyless entry system, wherein the keyless entry system is configured to control access to a vehicle, a residential building, a commercial building, a facility, a fenced area, a container, or a room.

20. The system of claim 13, wherein the target identification information is one or more of a make and a model of a vehicle.

21. The system of claim 13, wherein the target identification information is chosen from a group including: a make of a vehicle, a model of a vehicle, an address, a global satellite navigation system coordinates, longitude and latitude, and media access control data.
